(19) United States
(12) Patent Application Publication
(10) Pub. No.: US 2025/0111576 A1
(43) Pub. Date: Apr. 3, 2025

(54) GRAPHICS PROCESSING

(71) Applicant: Arm Limited, Cambridge (GB)

(72) Inventors: Rafal Stepuch, Cambridge (GB); Andreas Due Engh-Halstvedt, Trondheim (NO); Frank Klaeboe Langtind, Melhus (NO)

(73) Assignee: Arm Limited, Cambridge (GB)

(21) Appl. No.: 18/478,666

(22) Filed: Sep. 29, 2023

(51) Int. Cl. G06T 15/00; G06T 15/04

(52) U.S. Cl. CPC G06T 15/005; G06T 15/04

(57) ABSTRACT

When preparing and storing primitive lists in a tile-based graphics processing system, one or more primitive list pointer arrays store pointers, each pointer indicating a location in storage of one or more of the primitive lists. A further pointer array stores further pointers, each further pointer indicating a location in storage of one or more of the primitive list pointer arrays.

### BACKGROUND

The technology described herein relates to graphics processing, and in particular to operating a tile-based graphics processing pipeline.

Graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles.

The primitives for an output such as a frame to be displayed are usually generated by the application program interface for the graphics processing system, using the graphics drawing instructions (requests) received from the application (e.g. game) that requires the graphics processing.

Each primitive is usually defined by and represented as a set of vertices, where each vertex typically has associated with it a set of “attributes”, i.e. a set of data values for the vertex. These attributes will typically include position data and other, non-position data (varyings), e.g. defining colour, light, normal, texture coordinates, etc, for the vertex in question.

For a given output, e.g. frame to be displayed, to be generated by graphics processing, there will typically be a set of vertices defined for the output in question. The primitives to be processed for the output will then be indicated as comprising given vertices in the set of vertices for the graphics processing output being generated. Typically, the overall output, e.g. frame to be generated, will be divided into smaller units of processing, referred to as “draw calls”. Each draw call will have a respective set of vertices defined for it and a set of primitives that use those vertices.

Once primitives and their vertices have been generated and defined, they can be processed in order to generate the desired graphics processing output (render output), such as a frame for display. This basically involves rendering the primitives (e.g. performing rasterising, ray tracing, or other suitable rendering processes) to generate the graphics processing output.

One form of graphics processing is so called tile-based graphics processing, wherein the two-dimensional render output is rendered as a plurality of smaller area sub-regions, usually referred to as “tiles”. The tiles are each rendered separately (e.g. one after another). The rendered tiles are then combined to provide the complete rendering output (e.g. frame for display).

Other terms that are commonly used for “tile-based” rendering include “chunking” (the rendering tiles are referred to as “chunks”) and “bucket” rendering. The terms “tile” and “tile-based” rending will be used hereinafter for convenience, but it should be understood that these terms are intended to encompass all alternative and equivalent terms and techniques.

In a tile-based graphics processing system, it is accordingly usually desirable to be able to identify and know those primitives that are actually present in a given rendering tile so as to, e.g., avoid unnecessarily rendering primitives that are not actually present in a tile. Accordingly, in tile-based graphics processing, primitives to be processed for a given output (e.g. that make up the draw call currently being processed) are usually sorted into respective primitive lists that indicate for respective regions of the graphics processing output (render output), which primitives are to be processed for the region in question. The regions for which primitive lists are prepared in this regard may for example correspond to individual rendering tiles, or sets of plural rendering tiles. A given primitive may be included in more than one primitive list, e.g. where the primitive falls in more than one region.

Thus, in a tile based graphics processing system there will be an initial processing pass which, in effect, sorts the graphics primitives (and/or other graphics entities) to be processed into regions that the render output is divided into for sorting purposes. This initial processing pass is performed for all the geometry (primitives), etc., for the render output unit of processing (e.g. draw call) to be processed. The rasterising and rendering of the geometry (primitives) in the tiles to generate the render output is then done once the initial processing to sort the geometry, etc. into the regions has been completed.

Tile based graphics processing pipelines can accordingly be thought of as (and referred to as) “deferred” graphics processing pipelines (graphics processors) (and to perform “deferred” rendering). This is because the rasterising and rendering pass is deferred until suitable lists of primitives to be processed have been prepared for the regions that the render output has been divided into for sorting purposes.

When performing tile based rendering, primitive lists that are prepared for respective regions are stored in memory. Usually, the location in memory of a (and each) primitive list is tracked and stored, so that primitive lists can subsequently be accessed to determine which graphics primitives are present in a given rendering tile.

In some tile based graphics processing systems, primitive lists are prepared for plural sets of regions. This accordingly increases the (maximum) number of primitive lists that are prepared, and therefore in turn increases the burden of tracking and storing the locations of the primitive lists in memory.

For example, some tile based graphics processing systems use hierarchical tiling arrangements (as described, for example, in U.S. Pat. No. 10,019,820 B2, the contents of which is incorporated herein in its entirety) where primitive lists are prepared for plural sets of regions, with each set of regions corresponding to a level in a hierarchy of sets of regions, wherein regions in progressively higher levels of the hierarchy are, for example, progressively larger.

It is also known to perform so-called “layered rendering”, in which multiple layers, for example each representing different components of a scene to be displayed, for example different objects in the scene, are rendered separately and are available to use individually.

When performing layered rendering in a tile-based system, primitive lists will accordingly be prepared for each render layer. Correspondingly, when performing hierarchical tiling, primitive lists will be prepared for multiple hierarchical levels for each layer.

This all has the effect that the maximum number of primitive lists that need to be prepared, and therefore the number of locations of primitive lists that could have to be tracked and stored, may, at least for some graphics processing render outputs, be very large. This can accordingly result in a significant burden in relation to storing and handling of the primitive lists.

The Applicants believe that there remains scope for improvements to the handling of primitive lists in tile-based graphics processing systems.

### BRIEF DESCRIPTION OF THE DRAWINGS

Embodiments of the technology described herein will now be described by way of example only and with reference to the accompanying drawings, in which:

FIG. 1 shows a graphics processing system which can be operated in accordance with an embodiment of the technology described herein;

FIG. 2 shows schematically a graphics processor that may be operated in accordance with an embodiment of the technology described herein;

FIG. 3 shows schematically a set of primitives in a frame to be rendered;

FIG. 4 shows schematically an arrangement of sets of sub-regions of a frame to be rendered;

FIG. 5 shows an example structure for storing locations of primitive lists;

FIG. 6 shows a flow chart illustrating a method of storing locations of primitive lists in the structure of FIG. 5;

FIG. 7 shows schematically a structure for storing locations of primitive lists according to an embodiment of the technology described herein;

FIG. 8 shows a flow chart illustrating a method of storing locations of primitive lists in the structure of FIG. 7, according to an embodiment of the technology described herein;

FIG. 9 shows schematically a structure for storing locations of primitive lists according to an embodiment of the technology described herein;

FIG. 10 shows a flow chart illustrating a method of storing locations of primitive lists in the structure of FIG. 9, according to an embodiment of the technology described herein;

Like reference numerals are used for like elements in the Figures, where appropriate.

### DESCRIPTION

A first embodiment of the technology described herein comprises a method of preparing and storing primitive lists for use in a tile-based graphics processing system, in which a render output to be generated is divided into a plurality of tiles for rendering purposes, with each tile of the render output being rendered separately, the method comprising:
preparing and storing one or more primitive lists, each primitive list indicating graphics primitives to be processed for a region of the render output;
storing in one or more primitive list pointer arrays, one or more pointers, each pointer indicating a location in storage of one or more of the primitive lists; and
storing in a further pointer array, one or more further pointers, each further pointer indicating a location in storage of one or more of the primitive list pointer arrays.

A second embodiment of the technology described herein comprises a tile-based graphics processor, the graphics processor operable to render graphics processing render outputs in a tile-based manner, in which a render output being generated is divided into a plurality of tiles for rendering purposes, with each tile of the render output being rendered separately;
and the graphics processor comprising:
a tiling circuit configured to prepare and store in memory, a primitive list comprising graphics primitives to be processed for each of one or more regions of a render output to be generated;
wherein the tiling circuit is configured to, when preparing and storing primitive lists:
store in one or more primitive list pointer arrays, one or more pointers, each pointer indicating a location in memory of one or more of the primitive lists; and
store in a further pointer array, one or more further pointers, each further pointer indicating a location of one or more of the primitive list pointer arrays.

The technology described herein relates to the handling of primitive lists in tile-based graphics processing. In particular, the technology described herein relates to tracking and storing locations in memory of primitive lists.

In the technology described herein, one or more primitive list pointer arrays are stored, comprising one or more pointers, each pointer indicating a location in storage of one or more primitive lists. Furthermore, the technology described herein stores a further pointer array, comprising one or more further pointers, each further pointer indicating a location in storage of one or more primitive list pointer arrays.

As will be discussed further below, by generating and storing a further pointer in this manner, the technology described herein can make the tracking and storage of primitive lists more efficient (as compared, for example, to arrangements that simply use (and initialise) a primitive list pointer array that includes an entry for each primitive list that may be required.

For example, and as will be discussed in more detail below, the technology described herein can reduce the space in memory required for tracking and storage of primitive lists, and in particular provides more efficient allocation and initialisation of such space in memory.

For example, and in an embodiment, in the technology described herein space in storage for (only) the further pointer array may need to be initially allocated and initialised, with a (and each) primitive list pointer array being allocated and initialised (only) when it is determined that a graphics primitive is to be stored in a primitive list represented by the primitive list pointer array.

As noted above, the technology described herein relates to tile-based graphics processing, in which the render output (such as, e.g., a frame to be displayed) is divided into plural rendering tiles for rendering purposes (is processed on a tile-by-tile basis). Each rendering tile should, and in an embodiment does, span a (respective) sub-region (area) of the render output. The tiles that the render output is divided into for rendering purposes in the technology described herein can be any suitable and desired such tiles. The size and shape of the rendering tiles may be dictated by the tile configuration that the graphics processor is configured to use and handle.

In an embodiment the rendering tiles are all the same size and shape (i.e. in an embodiment regularly sized and shaped tiles are used), although this is not essential. The tiles are in an embodiment rectangular, and in an embodiment square. The size and number of tiles can be selected as desired. Each tile may correspond to an array of contiguous sampling positions, for example each tile being 16×16 or 32×32 or 64×64 sampling positions in size (wherein each sampling position may correspond to a pixel, or sub-pixel, for the render output). The render output may be divided into however many such tiles are required to span the render output, for the size and shape of the render output that is being used.

In the technology described herein, one or more, and in an embodiment plural, primitive lists are prepared and stored. Each primitive list identifies (lists) one or more primitives which are to be processed for a respective region (area) of the render output in question.

The regions for which primitive lists are prepared in an embodiment encompass (correspond to) one or more rendering tiles of the render output. For example, a primitive list region may correspond to a single rendering tile, or a set of plural rendering tiles. In an embodiment a region for which a primitive list is prepared corresponds to one or more contiguous tiles (and thus spans an array of contiguous sampling positions). A (and each) region for which a primitive list is prepared is in an embodiment rectangular (and in an embodiment square).

In an embodiment, there are plural sets of regions for which primitive lists can be prepared.

For example, where the tile based graphics processor performs hierarchical tiling, where there will be plural sets of regions for which primitive lists can be prepared, corresponding to different levels in the hierarchy. In this case, the regions in different sets of regions will differ in size (area), and the sets of regions will be arranged in a hierarchy of sets of regions, wherein each set of regions corresponds to a level in the hierarchy of sets of regions, and wherein regions in progressively higher levels of the hierarchy are progressively larger. Each set of regions (corresponding to a level in the hierarchy) in an embodiment spans the (entire) render output, such that the render output is effectively overlaid by plural levels of sets of regions (and accordingly wherein regions in different levels in the hierarchy may overlap one another).

In an embodiment, each region for which a primitive list can be prepared in a lowest level of the hierarchy corresponds to a single tile of the render output, with regions in successively higher levels encompassing progressively more tiles, e.g. corresponding to 2×2 tiles, 4×4 tiles, 8×8 tiles, etc. respectively (or any other suitable and desired increasing region size). Thus, the sets of regions in an embodiment comprise one set of regions in which each region of the set corresponds to a respective single rendering tile, and one or more (and in an embodiment more than one) sets of regions in which each region of the set corresponds to (encompasses) more than one rendering tile.

In an embodiment, regions in the same set of regions (same level of the hierarchy) are the same size and shape (for example, each encompassing the same number of tiles). In an embodiment, regions in the same set of regions (same level of the hierarchy) correspond to different regions of the render output (such that regions in the same set of regions do not overlap).

It will be apparent that, in such arrangements, regions in different sets of regions (different levels of the hierarchy) may encompass the same portion of a render output (albeit at a different resolution), such that a primitive may fall within one or more regions in different levels of the hierarchy (and correspondingly have one or more primitive lists into which it could be included). (Likewise, primitive lists for multiple different regions in different levels of the hierarchy may need to be consulted in order to identify primitives needed to render a tile).

In some embodiments, the render output (e.g. frame to be displayed) is generated as plural separate layers, e.g. with components of a scene (in an embodiment objects within the scene) to be rendered being assigned to respective different layers that are each rendered separately and are individually available (for the rendering application) to use.

In this case, a set of primitive lists (whether hierarchical or not) will need to be, and is in an embodiment, prepared for each layer of the render output, such that there will be a respective set (group) of one or more sets of regions for which primitive lists can be prepared for each respective different layer of the render output.

In this case therefore, there will be plural sets of regions for which primitive lists can be prepared, e.g. with each set of regions corresponding to a respective layer of the render output, or to a respective hierarchy level for a layer of the render output (where hierarchical tiling is being used).

The primitive list preparing process will, as will be appreciated by those skilled in the art, and in an embodiment does, sort a respective set of primitives for the render output into respective primitive lists.

The set of primitives which are to be processed for the render output (and for which primitive lists are to be prepared) may comprise any suitable (and, e.g., suitably “standalone”) set of primitives for the render output, such as the set of primitives for generating the entire (complete) render output, or (in an embodiment) a set of primitives for generating a respective portion of the render output (e.g. corresponding to a draw call).

In order to prepare the primitive lists, the primitives of the set of primitives may first be assembled, and it is then determined which region(s) of the render output the primitives fall within (and thus which primitive list(s) to include each primitive in).

Assembling the set of primitives may be performed by a suitable primitive assembly circuit. Assembling the set of primitives may be performed in any suitable and desired manner. For example, primitive assembly may comprise receiving information (e.g. indices) identifying vertices of a set of vertices to be used to form the primitives of the set of primitives, and then assembling primitives (determining the vertices corresponding to each primitive of the set of primitives) using the information (e.g. indices) identifying the vertices. The primitive assembly may be performed in accordance with information (primitive configuration information) indicating how the primitives are to be assembled, e.g. indicating whether primitives in the form of simple triangles, triangle strips, or triangle fans, etc., should be generated from the set of vertices.

To prepare the primitive lists (to identify primitives to be included in a (respective) primitive list, the (assembled) primitives are sorted (binned) into one or more primitive lists based on the region(s) of the render output which the primitives at least partially fall within.

Which region(s) a primitive (at least in part) falls within (and accordingly which primitive lists a primitive could be included in) will be, and is in an embodiment, determined based on the position of the primitive in the render output. The position of the primitive in the render output may be, and is in an embodiment, determined based on the positions of the vertices of the primitive.

Furthermore, when layered rendering is performed, which region a primitive (at least in part) falls within (and accordingly which primitive lists a primitive could be included in) is further determined based on an indication of which layer(s) the primitive is for. In this case, it is in an embodiment first determined which layer a primitive is for, and then the positions of the vertices are used to determine which regions in the set(s) of primitive listing regions for that layer the primitive falls within (and so should be listed in primitive lists for).

The positions of the vertices of the primitives that are used for the primitive listing process should, and in an embodiment do, comprise the positions of the vertices in the “screen space” of the render output.

Thus, in an embodiment, appropriate position shading for the vertices of the primitives is performed to transform (shade) the positions (position attributes) of the vertices as appropriate for the render output. The so transformed (shaded) positions are in an embodiment then used for preparing the primitive lists.

The position shading may be performed, e.g. before or after primitive assembly.

Hence, in embodiments, prior to sorting primitives of the set of primitives to be processed for the render output into primitive lists, processing of one or more position attributes (position shading) is performed for vertices of a set of vertices to be used to form the set of primitives. Correspondingly, when preparing primitive lists, the region(s) which a primitive falls within (and accordingly which primitive lists the primitive could be listed in) is determined based on vertex shaded positions of the vertices of the primitive.

The determination of which region(s) a primitive falls within may use any suitable and desired technique, such as exact binning, or bounding box binning, or a combination of these techniques. In an embodiment bounding box binning is used when preparing primitive lists.

As noted above, in embodiments, primitive lists may be generated for a hierarchical arrangement of sets of regions of a render output (or layer of a render output). In this case, a given primitive could, for example, be equally listed in primitive lists at different levels of the hierarchy. In an embodiment therefore, it is determined which level of the hierarchy to list a primitive at.

This may be done in any suitable and desired manner.

In embodiments, a cost function is used to determine a particular level of the hierarchy of sets of regions at which a primitive should be listed. The cost function may account for (be based on), for example, a cost of reading a primitive from a primitive list, and/or a cost for writing a primitive to a primitive list for one or more different levels of the hierarchy, and/or the cost of processing a primitive for a tile.

Including (listing) a primitive in a primitive list (bin) may, and in an embodiment does, comprise listing appropriate data for the primitive in the primitive list, such as an identifier (e.g. an index) for the primitive, together with an indication of the vertices of the primitive (e.g. such as an index identifying each vertex of the primitive). In an embodiment the primitive lists comprise an appropriate sequence of commands, inter alia, identifying primitives to be processed for the render output region that the primitive list relates to.

There may be some (assembled) primitives of the set of primitives for the render output which are not listed in any primitive list, e.g. if those primitives fall outside the view frustrum or are otherwise culled (e.g. based on a facing direction culling test).

The primitive lists which are prepared may be stored in a suitable storage (e.g. memory, e.g. a local memory or in an embodiment a main memory of the graphics processing system which the graphics processor is part of), for use during later processing (e.g. such as, e.g. including one or more of rasterising, rendering, ray tracing, and any other suitable rendering processing).

As discussed above, the technology described herein relates in particular to tracking and storing the locations in which the primitive lists are stored.

In particular, in the technology described herein, the locations of the primitive lists are tracked and stored using one or more primitive list pointer arrays. A (and each) primitive list pointer array comprises one or more pointers, with each pointer indicating a location in storage of one or more of the primitive lists.

It would be possible for a (and in an embodiment each) pointer to indicate a location in storage of plural primitive lists, and in an embodiment that is what is done. For example, and in an embodiment, a pointer may indicate the location of plural primitive lists stored together, and further data, for example header data, may be used to determine the location of a particular one of these primitive lists. In another embodiment, a (and each) pointer may indicate the location of (another) array of pointers, said another array of pointers comprising pointers indicating the location of a primitive list or lists. Other arrangements would, of course, be possible.

In an embodiment, a (and each) pointer in a primitive list pointer array indicates a location of a respective (single) one of the primitive lists.

The pointers stored in the primitive list pointer array may be any suitable and desired pointers. For example, and in an embodiment, the primitive list pointer array may comprise a set of head pointers and a set of tail pointers, with a (and each) head pointer indicating a location of the beginning of a respective one or more primitive lists, and a (and each) tail pointer indicating a location of the end of a respective one or more primitive lists.

Of course, any other suitable arrangement of pointers may be used as desired.

The pointers may indicate a location in memory of a primitive list(s) in any suitable and desired way. For example, and in embodiments, the pointer(s) may indicate an (actual) address in memory or a virtual address. Alternatively, in embodiments, the pointer(s) may indicate an offset from a base (memory) address.

In an embodiment, a (and in an embodiment each) primitive list pointer array is associated with one or more regions for which primitive lists can be prepared, where the primitive list pointer array stores one or more pointers indicating the locations of primitive lists prepared for the one or more regions with which the primitive list pointer array is associated.

In some embodiments, as discussed above, there are plural sets of regions for which primitive lists can be prepared. In such embodiments, a (and in an embodiment each) primitive list pointer array is associated with a respective one or more (but not all) of the sets of regions for which primitive lists can be prepared. In an embodiment, there is a one to one correspondence between the primitive list pointer arrays and the sets of regions for which primitive lists can be prepared, i.e. such that a (and in an embodiment each) primitive list pointer array is associated with a respective one of the sets of regions for which primitive lists can be prepared.

For example, where the graphics processor performs layered rendering, as described above, sets of regions for which primitive lists can be prepared will correspond to different render layers. Accordingly, in such embodiments, primitive list pointer arrays are in an embodiment associated with one or more of the render layers, such that a (and each) primitive list pointer array, e.g., and in an embodiment, indicates the locations of primitive lists prepared for a (one or more, and in an embodiment one) respective render layer.

Similarly, where the graphics processor performs hierarchical tiling, sets of regions for which primitive lists can be prepared will correspond to different hierarchical levels. In this case, in an embodiment a (and each) primitive list pointer array is associated with a level of the hierarchy, such that a (and each) primitive list pointer array in an embodiment indicates the locations of primitive lists prepared for a (one) respective hierarchical level.

Correspondingly, where the graphics processor performs hierarchical tiling within layers when performing layered rendering, in an embodiment a (and each) primitive list pointer array may store the locations of primitive lists for a respective one of the hierarchical levels of a render layer, and/or a (and each) primitive list pointer array may store the locations of primitive lists for one or more of the hierarchical levels for a given (single) render layer.

Thus, in an embodiment where there are plural sets of regions for which primitive lists can be prepared, a (and in an embodiment each) primitive list pointer array stores locations in memory of primitive lists prepared for one or more (and in an embodiment one, and only one) of the sets of regions.

It will be appreciated that for at least some render outputs, there may be hierarchical levels within a render layer that do not contain primitives (and therefore for which primitive lists do not need to be generated or stored). As will be discussed in more detail below, a (and each) primitive list pointer array may be (and is in an embodiment) only allocated and initialised when it is determined that it is required for storing the location of a primitive list. By using separate primitive list pointer arrays for each hierarchical level within a (and each) render layer, the total amount of space in storage required for storing the primitive list pointer arrays may therefore be reduced, as primitive list pointer arrays can be allocated and initialised (only) for hierarchical levels within a (and each) render layer which are determined to contain primitives.

In other embodiments, a (and each) primitive list pointer array may store the locations for plural (and in an embodiment each) of the hierarchical levels for a respective render layer.

In this case, the total number of primitive lists pointer arrays that could be required for a render output may be reduced (corresponding in an embodiment to the total number of render layers). As will be discussed further below, in an embodiment the amount of memory space allocated and initialised for the further pointer array (which is in an embodiment done prior to any listing of primitives in primitive lists) is based on (dependent on) the number of primitive list pointer arrays that may be required. Accordingly, using an arrangement that will require fewer primitive list pointer arrays allows for more efficient allocation and initialisation of the further pointer array.

Accordingly, in an embodiment where there are multiple render layers for which primitive lists can be prepared, each layer comprising plural hierarchical levels, a (and each) primitive list pointer array indicates the location in memory of primitive lists for a respective one (and only one) of the hierarchical levels of a render layer.

In another embodiment where there are multiple render layers for which primitive lists can be prepared, each layer comprising plural hierarchical levels, a (and each) primitive list pointer array indicates the location in memory of primitive lists for each of the hierarchical levels of a respective render layer.

Primitive list pointer array(s) may be stored in any suitable and desired manner, as will be discussed further below.

In the technology described herein, a further pointer array is used to track and store the locations of the primitive list pointer array(s) (such that the primitive list pointer array(s) may be accessed during later processing).

The further pointer array comprises one or more further pointers, each further pointer indicating a location in storage of one or more of (and in an embodiment one (and only one) of) the primitive list pointer arrays.

For example, and in an embodiment, the further pointers may comprise head pointers, each indicating a location in storage of a start of one or more (and in an embodiment one) of the primitive list pointer arrays, and tail pointers, each indicating a location in storage of an end of one or more (and in an embodiment one) of the primitive list pointer arrays.

The further pointers may indicate a location in storage of one or more of the primitive list pointer arrays in any suitable and desired way. For example, the further pointers may indicate a real address in memory, a virtual address, or may indicate an offset from a base (memory) address.

The further pointer array will comprise one or more (and in an embodiment plural) entries for storing further pointers. In an embodiment, the further pointer array comprises an entry for a further pointer for each primitive list pointer array that could potentially be needed for the render output being generated (regardless of whether any primitives will actually be listed for a primitive list that the primitive list pointer array relates to).

For example, where a (and each) primitive list pointer array corresponds to a respective render layer, as described above, the further pointer array in an embodiment comprises sufficient entries to store a further pointer for each respective render layer. Similarly, where a (and each) primitive list pointer array corresponds to a respective hierarchical level (or a hierarchical level of a render layer), the further pointer array in an embodiment comprises sufficient entries to store a further pointer for each respective hierarchical level (or for each hierarchical level of each render layer).

Space in storage for the (entries for) the further pointer array may be allocated in any suitable and desired way.

For example, and in an embodiment, a contiguous block of memory space may be allocated for the further pointer array of sufficient size to store each of the entries of the further pointer array.

In an embodiment, the entries of the further pointer array are allocated space in storage prior to the start of listing of primitives in primitive lists.

In an embodiment, when memory space is allocated for the further pointer array, the further pointer array is initialised such that each entry for storing a further pointer comprises an indication that no location (pointer) is currently stored. For example, and in embodiments, entries of the further pointer array may be initialised to comprise null pointers. Alternatively, the further pointer array may comprise flags indicating whether entries are storing valid pointers.

In an embodiment, in contrast to the further pointer array, the primitive list pointer arrays are not allocated and initialised prior to the start of listing of primitives in primitive lists.

Thus, in an embodiment, only the further pointer array, and not the primitive list pointer arrays, are allocated and initialised prior to the start of listing of primitives in primitive lists. In this way, prior to the listing of primitives, only a relatively small amount of memory space needs to be allocated and initialised, as only space to indicate the locations of the primitive list pointer arrays, and not the primitive lists themselves, is allocated and initialised. As described above, this may be particularly beneficial when plural sets of primitive lists are prepared for a render output, such as when primitive lists can be prepared for multiple render layers and/or multiple levels of a hierarchy.

In embodiments, the primitive list pointer arrays are allocated and initialised (only) when they are required to store a location of (a pointer to) a primitive list. Accordingly, a (and each) primitive list pointer array is in an embodiment allocated space in memory and initialised only when it is determined that the primitive list pointer array is required to store a location of a primitive list.

In an embodiment, when a (and each) primitive list pointer array is allocated and initialised, a further pointer indicating a location of the primitive list pointer array is written to the further pointer array.

In this way, the total amount of space required to track and store primitive lists can be reduced, as primitive list pointer arrays are allocated and initialised (only) where needed.

In an embodiment, primitive list pointer arrays are allocated and initialised as part of the processing of primitives, in an embodiment during the sorting of primitives into primitive lists. Particularly, a (and each) primitive list pointer array is in an embodiment allocated memory space and initialised (only) when it is determined that a primitive will be listed in a primitive list that the primitive list pointer array relates to (i.e. in a primitive list that the primitive list pointer array will store the location for).

Accordingly, the process of sorting (tiling) a primitive into a primitive list or lists in an embodiment comprises determining which primitive list pointer array(s) is required to store location(s) of primitive list(s) that the primitive is to be listed in.

It can be determined which primitive list pointer arrays are required for a primitive in any suitable and desired way.

In an embodiment, it is determined which set of regions the primitive is to be listed for, and so which primitive list pointer array(s) is required to store the location of the primitive list(s) that the primitive will be listed in.

It would be possible to determine the set of regions that a primitive is to be listed for by determining which (individual) one or ones of the regions (and so which set(s) of regions) the primitive is to be listed for (and so which (specific) primitive list(s) the primitive is to be listed for), and in one embodiment that is what is done. For example, and in an embodiment, the region that a primitive is located in (and therefore the primitive list that the primitive is to be listed in) is determined in the usual way for the tile based graphics processing system, and it is then determined whether there is an existing primitive list for the region (and so if there is a corresponding primitive list pointer array for that primitive list).

However, in embodiments, it is determined which set of regions a primitive is to be listed for, and so which primitive list pointer array is required for the primitive, without (e.g. before completely) determining which specific region(s) of the set of regions the primitive is to be listed for. In this way, allocation of the primitive list pointer array required for a primitive list for the primitive may (if necessary) be commenced whilst the primitive is (still) being sorted into a (specific) primitive list or lists.

For example, and in an embodiment, when a (and each) primitive list pointer array stores locations of primitive lists for a respective render layer, it is in an embodiment determined which render layer a primitive relates to (applies to), and then it is determined whether the primitive list pointer array for that render layer has been allocated and initialised. The determination of which render layer a primitive relates to may be made in any suitable and desired way.

Similarly, and in another embodiment, when a (and each) primitive list pointer array stores locations of primitive lists for a respective hierarchical level (e.g. a hierarchical level of a render layer), then it is determined which hierarchical level the primitive is to be listed at, and then it is determined whether the primitive list pointer array for that hierarchical level has been allocated and initialised. The determination of which level of the render hierarchy a primitive is to be listed at may be made in any suitable and desired way, e.g. as described above.

When it has been determined which primitive list pointer array(s) is required for the primitive, in an embodiment it is then determined whether the primitive list pointer array(s) has (already) been allocated and initialised.

The determination of whether a primitive list pointer array has (already) been allocated and initialised may be made in any suitable and desired way.

In embodiments, the further pointer array is used to determine whether the primitive list pointer array has been allocated.

In an embodiment, if the further pointer array does not include a pointer indicating the location of the primitive list pointer array, for example if an entry in the further pointer array that corresponds to the primitive list pointer array comprises a null value, then it is determined that the primitive list pointer array has not been allocated.

Correspondingly, once it is determined that a primitive list pointer array is required for a primitive, it is in an embodiment then determined whether the entry (or entries) in the further pointer array for a pointer indicating a location in storage of that primitive list pointer array currently comprises a (valid) further pointer.

In an embodiment, when it has been determined that a primitive list pointer array has not (yet) been allocated for a set of primitive lists that a primitive to be processed is to be listed in, the primitive list pointer array for the set of primitive lists is allocated and initialised, and in an embodiment a (one or more) further pointer indicating a location in storage of the primitive list pointer array is written to the (appropriate entry in the) further pointer array.

Accordingly, in an embodiment, preparing and storing primitive lists comprises:
allocating memory space for the further pointer array, comprising one or more entries for storing further pointers for each of plural sets of regions for which primitive lists can be prepared; and
for a primitive for the render output:
   determining which set of regions the primitive is to be listed for;
   determining whether the further pointer array comprises a further pointer indicating a location in storage of a primitive list pointer array for the set of regions, and:
      when it is determined that the further pointer array does not comprise a further pointer indicating a location in storage of a primitive list pointer array for the set of regions:
         allocating and initialising a primitive list pointer array for the set of regions; and
         writing a further pointer indicating a location in storage of the primitive list pointer array in the further pointer array.

In this way, storage (e.g. memory) space is only provided for primitive list pointer arrays when it is determined that there is a primitive that will fall within a region associated with the primitive list pointer array. This means that primitive list pointer arrays are only allocated and initialised when they are needed. For example where each primitive list pointer array is associated with a render layer, primitive list pointer arrays are only allocated and initialised for render layers that are in use for a scene (and not for empty render layers). As such, primitive lists can be tracked and stored more efficiently.

Memory space for the primitive list pointer arrays may be allocated and initialised in any suitable and desired way.

In an embodiment, the memory space allocated for a primitive list pointer array is contiguous. In an embodiment, the memory space allocated for a primitive list pointer array comprises one or more entries for storing pointers. In an embodiment, the memory space allocated for a primitive list pointer array comprises sufficient entries for storing one or more pointers indicating a location for in storage of a primitive list for each region of the set of regions that the primitive list pointer array relates to.

For example, and in an embodiment, a (and each) primitive list pointer array may comprise an entry to store a location (pointer) for each primitive list for a render layer, or a hierarchical level, that the primitive list pointer array stores locations of primitive lists for.

It would be possible, when allocating the primitive list pointer array to also allocate memory space for the primitive lists, and in an embodiment that is what is done.

However, in an embodiment, memory space for the primitive lists is only allocated when it is required. Accordingly, when memory space is initialised for the primitive list pointer array, the primitive list pointer array is in an embodiment initialised such that each entry for storing pointers comprises an indication that no location is currently stored. For example, and in embodiments, entries of the primitive list pointer array may be initialised to comprise null pointers. Alternatively, the primitive list pointer array may comprise flags indicating whether entries are storing valid pointers.

If instead it is determined that a primitive list pointer array has already been allocated, then that primitive list pointer array is used to store a pointer(s) indicating the location in storage of the primitive list(s) in which the primitive is listed.

Once it has been determined which primitive list pointer array is required (and that primitive list pointer array has been allocated and initialised if necessary), the primitive may then be included in primitive lists, for example in the usual way for the graphics processor and graphics processing system in question.

The primitive lists may be stored in any suitable and desired way.

In embodiments, storage space for primitive lists is only allocated as (and when) a primitive is (first) determined to fall within a region that the primitive list corresponds to.

Accordingly, once storage space for a primitive list has been allocated, a location in memory of the primitive list is written to a primitive list pointer array that is associated with the set of regions that includes the region for which the primitive list is prepared.

In embodiments, primitives for layers or levels for which primitive list pointer arrays have already been allocated and initialised are allowed to be, and in an embodiment are, processed whilst (other) primitive list pointer arrays are being allocated and initialised.

Furthermore, in embodiments, primitive list pointers for a primitive list pointer array that is being allocated and initialised are in an embodiment cached (locally) (and used from the cache) whilst waiting for the primitive list pointer array to be allocated and initialised. This will then allow primitives for that primitive list pointer array to still be sorted into primitive lists whilst the primitive list pointer array is being initialised (such that the allocation and initialisation of the primitive list pointer array is done in a “non-blocking” manner (such that sorting of primitives into lists is not paused whilst a primitive list pointer array is initialised).

Once a primitive list pointer array has been initialised in memory, any cached primitive list pointers for that primitive array can be, and are in an embodiment, written out to the array in memory.

Accordingly, in an embodiment, storing in one or more primitive list pointer arrays, one or more pointers, each pointer indicating a location in storage of one or more of the primitive lists, comprises:
when a location in storage for a primitive list is allocated, writing a pointer indicating a location in storage of the primitive list to a cache; and
when a primitive list pointer array for storing the pointer has been initialised, writing the pointer from the cache to the primitive list pointer array.

In embodiments, further pointers for the further pointer array and the primitive list pointers for the primitive list pointer arrays are stored in the same cache.

After the primitive lists have been prepared, the primitive lists may be, and are in an embodiment, used for subsequent processing (of the primitives in the primitive lists). The subsequent processing may comprise, for example, and in an embodiment, rendering one or more tiles of the render output, using the primitive lists to identify primitives to be processed for a given tile.

The subsequent processing may be, and is in an embodiment, performed on a tile-by-tile basis (with each tile corresponding to a respective sub-region of the render output being processed separately (e.g. in turn)). The processing performed on a tile-by-tile basis may comprise any suitable and desired processing for rendering a tile of a render output, e.g. triangle setup, rasterising, depth culling, rendering (e.g. fragment shading and/or ray-tracing), etc.

The subsequent processing for a (and each) tile in an embodiment comprises identifying a primitive list or lists relevant to the tile to be processed (the relevant primitive list(s) each corresponding to a region of the render output which includes (some or all of) the tile), and using the identified primitive list(s) when processing the tile. This (in an embodiment) comprises reading the identified primitive lists to identify primitives to be processed for the tile from the primitive list(s), e.g. by a primitive list reader (primitive list reading circuit), and then processing the identified primitives.

In an embodiment, reading a (and each) primitive list comprises identifying the location of the primitive list in memory. In an embodiment, reading a primitive list comprises reading a further pointer from the further pointer array to determine a location of a primitive list pointer array that is associated with the region for which the primitive list has been prepared, and then reading a primitive list pointer from the primitive list pointer array to determine a location of the primitive list itself.

The technology described herein extends to such reading of primitive lists.

Thus, an embodiment of the technology described herein comprises a method of reading primitive lists when performing tile-based graphics processing in which a render output to be generated is divided into a plurality of tiles for rendering purposes, with each tile of the render output being rendered separately, the method comprising:
when reading a primitive list to identify a primitive(s) to process for a tile of a render output:
reading a further pointer from a further pointer array that stores one or more further pointers, each further pointer indicating a location in storage of one or more primitive list pointer arrays, to determine a location in storage of a primitive list pointer array comprising a pointer indicating the location in storage of the primitive list;
reading a pointer from the primitive list pointer array that indicates the location in storage of the primitive list; and
reading the primitive list to identify a primitive(s) to be processed.

Another embodiment of the technology described herein comprises a primitive list reading circuit for a tile-based graphics processor that is operable to perform tile based graphics processing in which a render output to be generated is divided into a plurality of tiles for rendering purposes, with each tile of the render output being rendered separately, wherein the primitive list reading circuit is configured to:
read primitive lists to identify graphics primitives to process for a tile of a render output;
and comprises:
a further pointer array reading circuit, configured to, when the primitive list circuit is to read a primitive list to identify a primitive(s) to process for a tile of a render output:
   read a further pointer from a further pointer array that stores one or more further pointers, each further pointer indicating a location in storage of one or more primitive list pointer arrays, to determine a location in storage of a primitive list pointer array comprising a pointer indicating the location in storage of the primitive list; and
a primitive list pointer array reading circuit, configured to:
read a pointer from the primitive list pointer array that indicates a location in storage of a primitive list.

As will be appreciated by those skilled in the art, these embodiments of the technology described herein may, and in an embodiment do, comprise any one or more or all of the features of the technology described herein, as appropriate.

The graphics processor (and system) of the technology described herein can be any suitable and desired (tile-based) graphics processor (and system).

The output to be generated may comprise any suitable output that can be generated by a graphics processor, such as a frame for display, or render-to-texture output, etc. The output data values from the processing are in an embodiment exported to external, e.g. main, memory, for storage and use, such as to a frame buffer for a display. In an embodiment, the output is an output frame in a sequence of plural output frames (e.g. to be displayed) that the graphics processor (and system) generates.

The graphics processor (graphics processing unit (GPU)) should, and in an embodiment does, execute a graphics processing pipeline. The graphics processor can execute any suitable and desired graphics processing pipeline, and may and in an embodiment does, include any suitable and desired processing circuits, processing logic, components and elements for that purpose.

The graphics processing pipeline that the graphics processor executes can include any suitable and desired processing stages for generating a (the) graphics output (e.g. frame). Thus, the graphics processing pipeline can include, and in an embodiment does include any one or one or more, and in an embodiment all, of the processing stages that graphics processing pipelines normally include. Thus, for example, the graphics processing pipeline in an embodiment includes a vertex shading stage, primitive setup stage, a rasteriser and a renderer. In an embodiment the renderer is in the form of or includes a fragment shader.

The graphics processing pipeline may also contain any other suitable and desired processing stages that a graphics processing pipeline may contain such as a depth (or depth and stencil) tester, a blender, etc. As the pipeline is a tile-based pipeline, the pipeline in an embodiment also comprises a tiling stage, and/or a tile buffer for storing tile sample values and/or a write out unit that operates to write the data in the tile buffer (e.g. once the data in the tile buffer is complete) out to external (main) memory (e.g. to a frame buffer).

A (and each) processing stage (circuit) of the graphics processing pipeline (processor) can be implemented as desired, e.g. as a fixed function hardware unit (circuit) or as a programmable processing circuit (that is programmed to perform the desired operation). In an embodiment, at least the vertex shading stage and/or the fragment shading stage are implemented by a programmable execution unit (shader core) of the graphics processor executing an appropriate shader (program) that is in an embodiment supplied by the application that requires the graphics processing.

The graphics processing system can include any (other) suitable and desired components. In an embodiment, the graphics processing system includes a host processor which is operable to issue graphics processing commands (and data) to the graphics processor (GPU).

Thus, the graphics processing pipeline is in an embodiment executed (by the graphics processor (GPU)) in response to commands issued by a host processor of the graphics processing system. The host processor can be any suitable and desired processor, such as and in an embodiment a central processing unit (CPU), of the graphics processing system.

In an embodiment, the host processor of the graphics processing system generates the graphics processing commands (and data) for the graphics processor (GPU) in response to instructions from an application executing on the host processor. This is in an embodiment done by a driver for the graphics processor (GPU) that is executing on the host processor.

The graphics processing system should, and in an embodiment does, (further) comprise a memory. The memory can be any suitable and desired storage. The memory may be an on-chip memory (i.e. on the same chip as the host processor and/or the graphics processor) or it may be an external (main) memory (i.e. not on the same chip as the host processor and/or the graphics processor). Where the memory is an external memory, it may be connected to the host processor and/or to the graphics processor by a suitable interconnect.

In an embodiment, the various functions of the technology described herein are carried out on a single graphics processing platform that generates and outputs data (such as rendered fragment data that is, e.g., written to the frame buffer), for example for a display device.

The technology described herein can be implemented in any suitable system, such as a suitably configured micro-processor based system. In an embodiment, the technology described herein is implemented in a computer and/or micro-processor based system.

The technology described herein is in an embodiment implemented in a portable device, such as, and in an embodiment, a mobile phone or tablet.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuits, circuitry, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, etc., if desired.

It will also be appreciated by those skilled in the art that all of the described embodiments of the technology described herein can include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

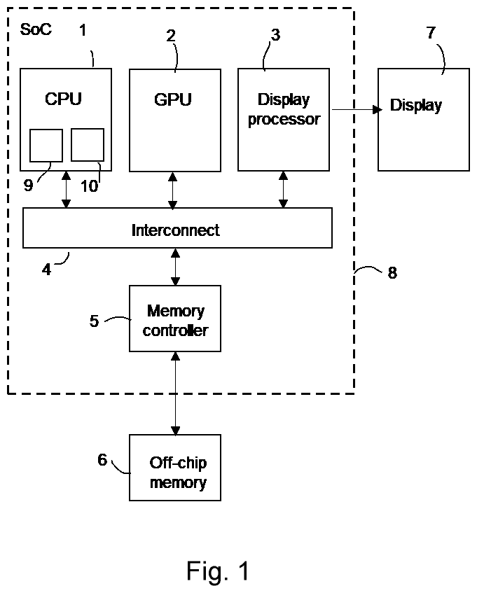

FIG. 1 shows an exemplary system on chip (SoC) graphics processing system 8 that comprises a host processor comprising a central processing unit (CPU) 1, a graphics processor (GPU) 2, a display processor 3, and a memory controller 5. The exemplary data processing system may also comprise a video engine (not shown in FIG. 1). As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

In the present embodiment, the graphics processor 2 executes a graphics processing pipeline that processes graphics primitives, such as triangles, when generating an output, such as an image for display.

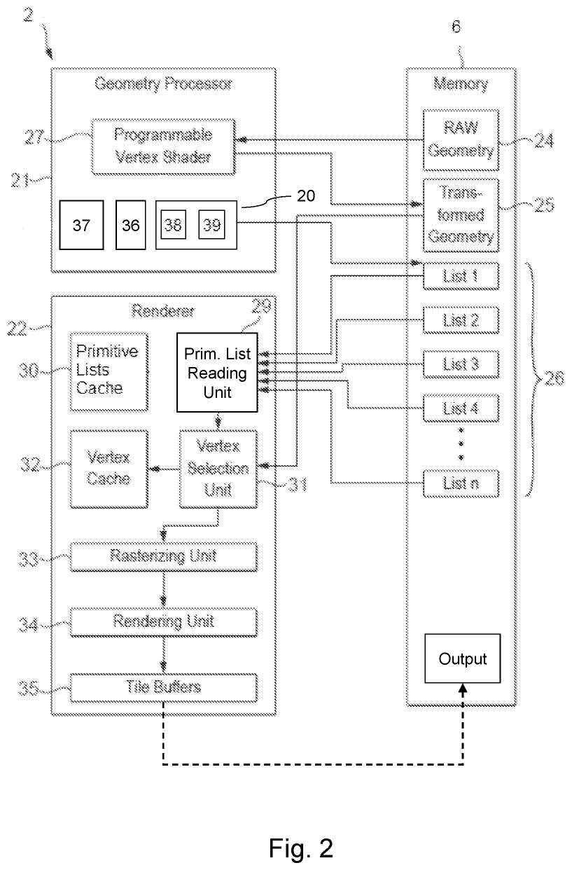

FIG. 2 shows schematically a graphics processor 2 that may be operated in accordance with the technology described herein. FIG. 2 shows the main elements and pipeline stages/circuits of the graphics processor 2 that are relevant to operation in the manner of the technology described herein. As will be appreciated by those skilled in the art there may be other elements of the graphics processor and processing pipeline that are not illustrated in FIG. 2. It should also be noted here that FIG. 2 is only schematic, and that, for example, in practice the shown functional units and pipeline stages may share significant hardware circuits, even though they are shown schematically as separate stages in FIG. 2. It will also be appreciated that each of the stages, elements and units, etc., of the graphics processor and processing pipeline as shown in FIG. 2 may, unless otherwise indicated, be implemented as desired and will accordingly comprise, e.g., appropriate circuitry, circuits and/or processing logic, etc., for performing the necessary operation and functions.

The graphics processor 2 includes a geometry processor 21, and a renderer 22, both of which can access a memory 6. The memory 6 may be “on chip” with the geometry processor 21 and renderer 22, or may be an external memory that can be accessed by the geometry processor 21 and renderer 22.

The memory 6 stores, inter alia, and as shown in FIG. 2, a set of raw geometry data 24 (which is, for example, provided by the graphics processor driver or an API running on a host system (microprocessor) of the graphics processor 2), a set of transformed geometry data 25 (which is the result of various transformation and processing operations carried out on the raw geometry 24), and a set of primitive lists 26.

Each primitive list 26 corresponds to a particular region of the render output being generated, and contains a list of primitives to be rendered for that region.

The transformed geometry data 25 comprises, for example, transformed vertices (vertex data), etc.

The geometry processor 21 comprises, inter alia, a programmable vertex shader 27, a primitive assembly stage 37, and a tiling unit (a tiler) 20 comprising a primitive binning unit 38 and a primitive list writing unit 39.

The programmable vertex shader 27 takes as it input the raw geometry data 24 stored in the memory 6, and processes that data to provide transformed geometry data 25 (which it then stores in the memory 23) comprising the geometry data in a form that is ready for two-dimensional (‘2D’) placement in the frame to be displayed.

The programmable vertex shader 27 and the processes it carries out can take any suitable form and be any suitable and desired such processes. The primitive assembly stage 37 takes as its input the transformed and processed vertex data from the programmable vertex shader 27, and assembles geometric primitives using that data.

The tiling unit 20 carries out the tiling and primitive list writing processes, in order to generate primitive lists 26 which are subsequently used by the renderer 22. To do this, the tiling unit 20 takes as its input the assembled primitives from the primitive assembly stage 37. The binning unit 38 of the tiling unit 20 determines the (primitive listing) regions of the render output that a primitive (at least partially) falls within (e.g. using a bounding box technique), and the primitive list writing unit 39 writes “binned” primitives to primitive lists 26 which are stored in memory 6.

The renderer 22 includes a primitive list reading unit 29, a primitive list cache 30, a vertex selection unit 31, a vertex data cache 32, a rasterising unit 33, a rendering unit 34, and tile buffers 35. The renderer operates on a tile-by-tile basis.

The rasterising unit 33, rendering unit 34, and tile buffers 35 operate, in this embodiment, in the same manner as such units normally operate in graphics processing systems. Thus the rasterising unit 33 takes as its input a primitive and its vertices, rasterises the primitive to fragments, and provides those fragments to the rendering unit 34. The rendering unit 34 then performs a number of rendering processes, such as texture mapping, blending, fragment shading, etc. on the fragments, to generate rendered fragment data for the fragments.

The output of the rendering 34 (the rendered fragments) is written to a tile buffer 35. Once the processing for the tile in question has been completed, then the tile will be written to an output data array 23 in memory, and the next tile processed, and so on, until the complete output data array has been generated. The process will then move on to the next output data array (e.g. frame), and so on.

The output data array may typically be an image (a frame) intended for display on a display device, such as a screen or printer, but may also, for example, comprise intermediate render data intended for use in later rendering passes (also known as a “render to texture” output), or for deferred rendering, or for ray tracing, etc.

The primitive list reading unit 29 of the renderer 22 determines which primitive is to be rendered next. It does this by considering the primitive list(s) 26 stored in the memory 6 that apply to the tile being rendered, and reading from that list(s) the next primitive to be rendered.

To do this, the primitive list reading unit 29 first fetches the required primitive list(s) into the primitive list cache 30, and then reads the cached primitive list(s) to determine the primitive to be rendered next.

The primitive list reading unit 29 provides the primitive that it has read for rendering next to the vertex selection unit 31. In response to this, the vertex selection unit 31 retrieves the appropriate transformed vertex data for the primitive in question from the transformed geometry data 25 stored in the memory 23, and then provides the primitive (i.e. its transformed vertex data) to the rasterising unit 33 for processing. The vertex selection unit 31 can cache vertex data that it has retrieved from the memory 23 in the vertex data cache 32, if desired.

As discussed above, the technology described herein and the present embodiments relate in particular to the tracking and storing, and then use, of the primitive lists 26 that are generated by the tiler 20 and stored in the memory 6.

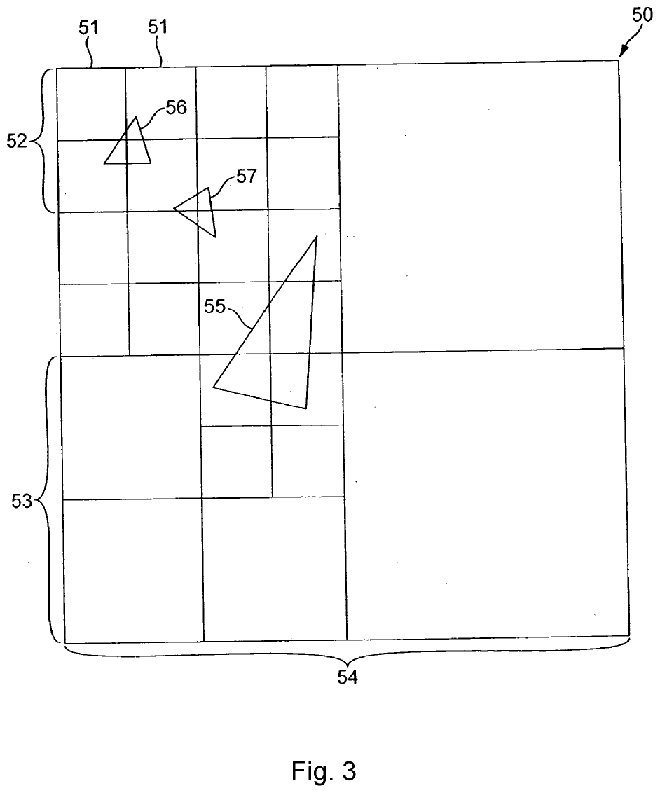

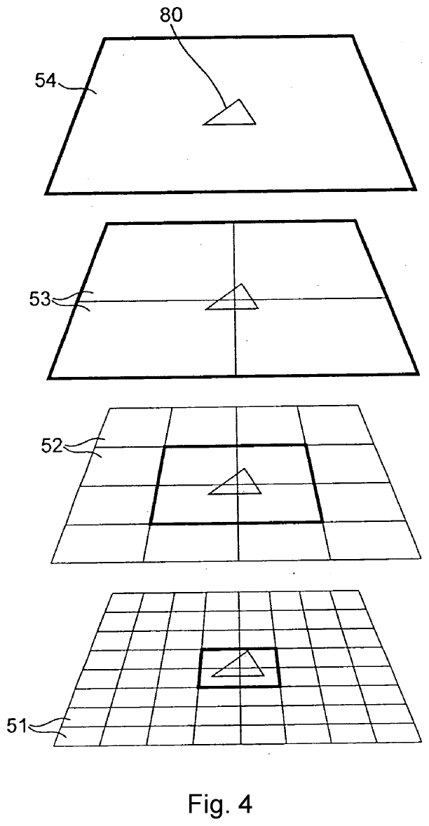

In the present embodiments, hierarchical tiling is performed, as illustrated in FIGS. 3 and 4. As shown in FIG. 3, the frame 50 to be rendered is divided into plural individual primitive-listing sub regions 51, in this embodiment each corresponding to a rendering tile. (It should be noted here that FIG. 3 does not show all the individual primitive listing sub regions 51 that the frame 50 is divided into, but only a few of those sub regions. This is for clarity purposes. However, the entire frame 50 is divided into equal sub regions 51 in practice.)

The individual sub regions 51 are also grouped into differing groups of sets of plural sub regions, which groups of sets of sub regions are in effect laid over the frame 50 to provide different levels having different divisions of the overall frame area. Thus, as shown in FIG. 3, there is a “level” of sixteen 2×2 tile sub regions 52. There is then another, lower resolution level comprising four 4×4 tile sub regions 53. Finally, there is one 8×8 tile sub region 54 which encompasses the entire frame area.

As can be seen from FIG. 3, the effect of this arrangement is that the frame 50 is overlaid with a progressively increasing hierarchy of screen area divisions. This is shown schematically in FIG. 4. Thus there is a top level level comprising a set 54 of 8×8 tile sub regions which encompasses the entire frame area 50. There is then a set of four 4×4 tile sub regions 53, then a set of sixteen 2×2 tile sub regions 52, and finally a set (level) comprising the 64 single tile sub regions 51. FIG. 4 also shows in bold for illustrative purposes the sub regions or sets of sub regions that a primitive 80 would be considered to fall within at each level in the hierarchy.

FIG. 3 also shows for illustrative purposes three primitives 55, 56 and 57 which are to be rendered and which accordingly need allocating to primitive lists for rendering.

(Again, as will be appreciated by those skilled in the art, in practice any given frame to be rendered will typically comprise many more primitives than the three primitives shown in FIG. 3. However, FIG. 3 shows three primitives only for simplicity and clarity purposes.)

As discussed above, in a system where the frame 50 to be rendered is divided into smaller tiles 51 for rendering purposes, it is necessary for the system to be able to identify which primitives should be rendered for each tile. This is done, by providing so called primitive or tile lists, which identify for each respective sub region the primitives that should be rendered for that sub region.

In the present embodiment, the tiling unit 20 prepares a primitive list for each individual tile sub region 51, a separate primitive list for each 2×2 tile sub region 52, a separate primitive list for each 4×4 tile sub region 53, and a separate primitive list for the 8×8 tile sub region 54 that covers the entire frame 50. To do this, the tiling unit takes each primitive in turn, determines a location for that primitive, compares the primitive's location with the locations of (the frame area covered by) the tile sub regions 51 and the locations of (the frame area covered by) the larger sub regions 52, 53 and 54, and allocates the primitive to the respective primitive lists 26 for the sub regions accordingly.

Furthermore, in the present embodiments, layered rendering may be performed. In layered rendering graphics primitives 55, 56, 57 are each assigned to one or more of a plurality of different render layers, with each render layer rendered separately. Primitive lists are prepared for each of the different render layers.

In the present embodiments, both hierarchical tiling and layered rendering may be performed. In this case, primitive lists are prepared for plural sets of sub regions 51, 52, 53, 54 corresponding to different hierarchical levels, for each of the respective render layers.

As discussed above, the technology described herein relates to the tracking and storage of primitive lists.

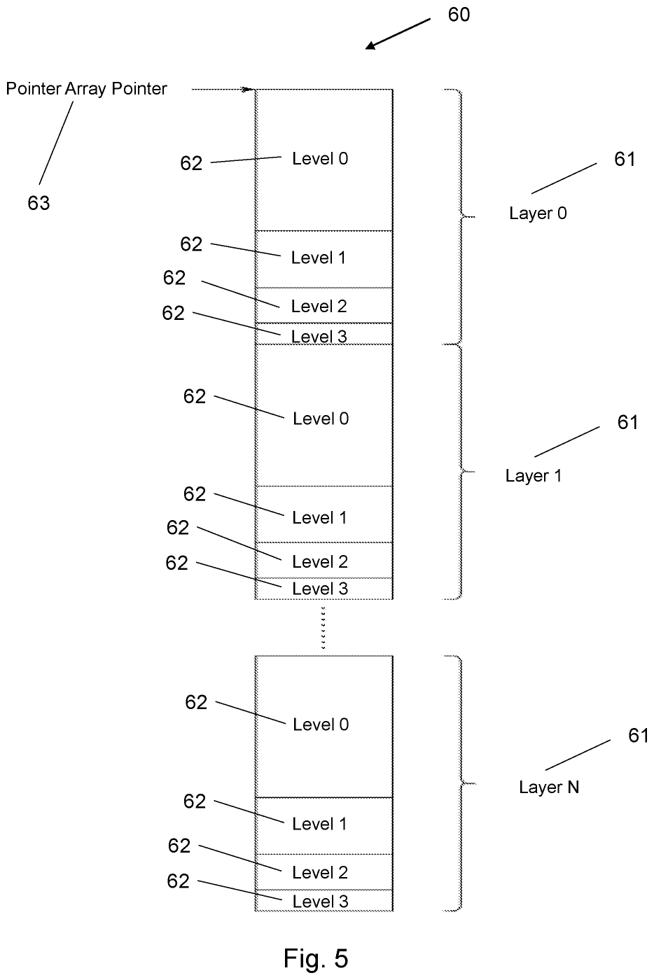

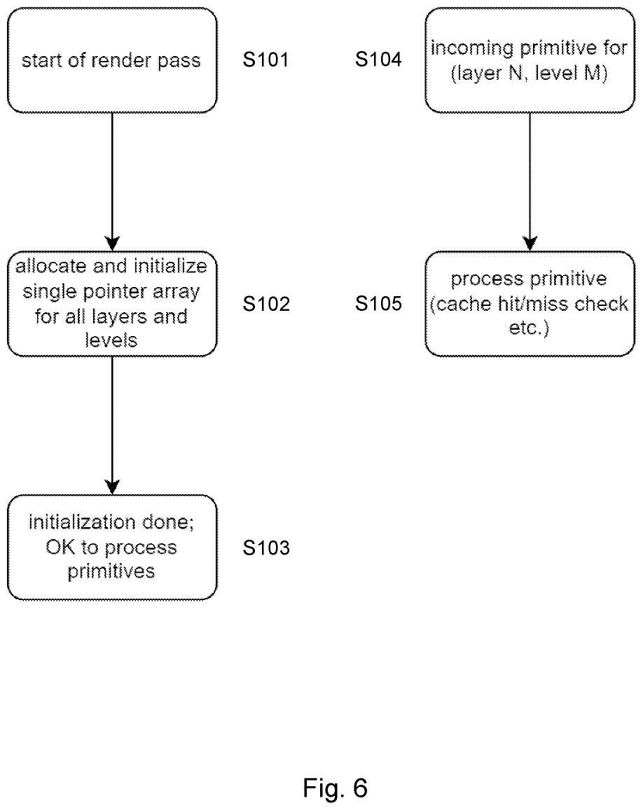

FIGS. 5 and 6 illustrate an example way in which primitive lists can be stored. As discussed above, when both hierarchical tiling and layered rendering are performed, primitive lists are (potentially) prepared for plural sets of sub regions, corresponding to different hierarchical levels for different render layers.

In FIG. 5, it is assumed that primitive lists may be prepared for four hierarchical levels for each of render layers 0 to N. Pointers indicating the locations in memory of each primitive list are stored in a single pointer array 60. For example, in FIG. 5 the single pointer array 60 includes pointers indicating the location of primitive lists for each of N+1 render layers 61. The pointers for a (and each) render layer include pointers indicating primitive lists for each of four hierarchical levels 62. A pointer array pointer 63 indicates the location of the pointer array 60.

FIG. 6 illustrates the generation of the primitive list pointer array 60 of FIG. 5. Firstly, at the start of the render pass S101, the single pointer array 60 is allocated and initialized S102 for all layers 61 and hierarchical levels 62. The allocation and initialization of the pointer array 60 may be performed in any suitable and desired way.

Once the pointer array 60 has been initialized, primitives are processed S103. For a (and each) incoming primitive it is determined which render layer and hierarchical level the incoming primitive is to be listed for (S104), and then the primitive is processed (S105), to sort the primitive into (and to write the primitive to) a primitive list or lists. If the primitive is the first primitive to be stored for a primitive list, a pointer indicating the location of the primitive list is written to the single pointer array 60.

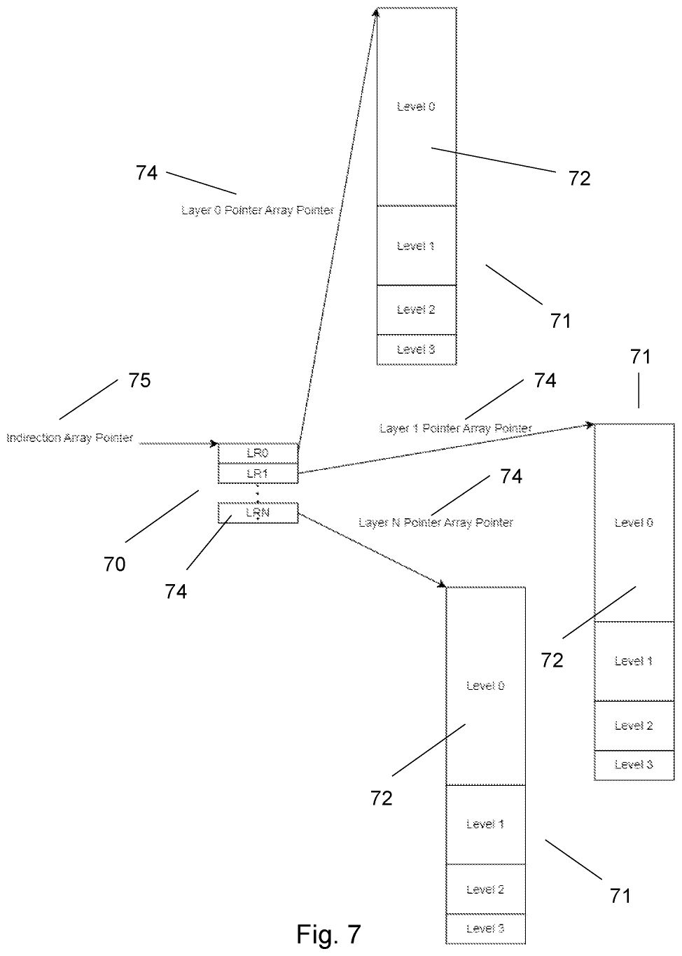

FIGS. 7 to 10 illustrate ways in which locations of primitive lists can be tracked and stored, in accordance with embodiments of the technology described herein.

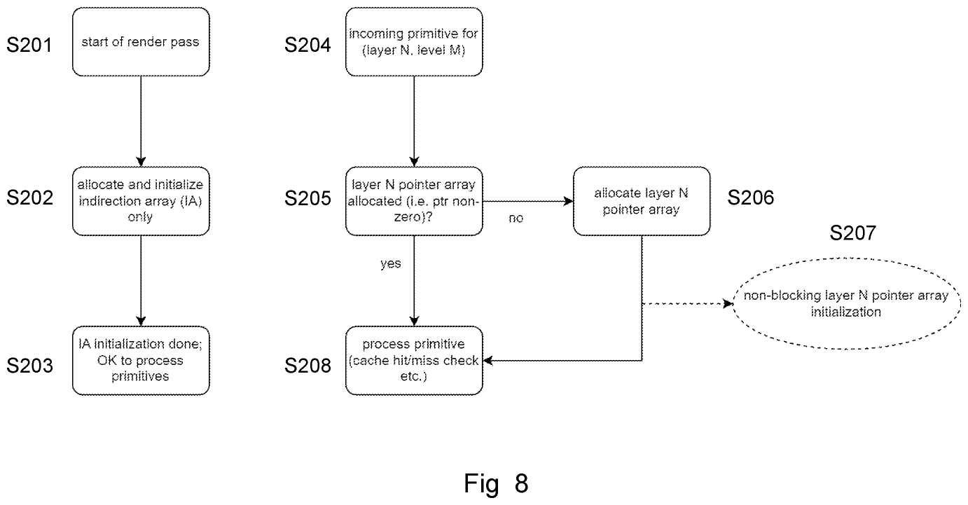

FIGS. 7 and 8 illustrate the storage of locations of primitive lists in a first embodiment of the technology described herein.

FIG. 7 shows the data structure used for indicating primitive list locations in this embodiment. As shown in FIG. 7, a separate primitive list pointer array 71 is used to store pointers 72 indicating the location of primitive lists for each particular render layer.

A further pointer array (an indirection array) 70 is then used to store (further) pointers 74 that indicate the locations of the respective primitive list pointer arrays 71.

The further pointer array 70 has an entry for storing a (further) pointer 74 indicating a location in storage for each primitive list pointer array that could be required, and so in the present embodiment includes an entry for each respective render layer (that the graphics processor can potentially be required to generate).

An indirection array pointer 75 indicates the location of this further pointer array 74.

FIG. 8 shows an embodiment for storing primitive list locations using the data structures of FIG. 7.

At the start of the render pass S201, unlike the example of FIGS. 5 and 6, only memory space for the further pointer array (indirection array) 70 is allocated and initialised S202 (no memory space is allocated and initialised for the primitive list pointer arrays 71 at this point). In this embodiment, the further pointer array 70 is initialised by writing zero values to each entry in the array.

Once the further pointer array 70 has been initialised, primitives can be processed S203.

For an incoming primitive located in a particular render layer S204, it is determined whether the primitive list pointer array 71 for that particular render layer has already been allocated S205. In this embodiment, this is done by checking the further pointer array 70 to determine whether there is a (further) pointer 74 indicating the location of the primitive list pointer array 71 for that particular render layer, or whether there is a zero (null) value in the entry that corresponds to that particular render layer.

When it is determined that there is a (further) pointer 74 in the further pointer array 70 indicating the location of the primitive list pointer array 71 for the layer for the primitive in question, then that (further) pointer 74 is used to determine the location of the primitive list pointer array 71 for the layer, and the primitive is processed S208 and added to the desired primitive lists(s) for that layer.

When it is determined that there is not a (further) pointer 74 indicating a location of a primitive list pointer array 71 for the layer, the primitive list pointer array 71 for the layer is allocated S206 and initialised S207, and a (further) pointer 74 indicating the location of the (new) primitive list pointer array 71 is written to the corresponding entry in the further pointer array 70.

Again, the primitive is processed S208 and added to the desired primitive list(s) for that layer.

If the primitive is to be added to an existing primitive list, then the primitive is simply added to the existing primitive list.

If the primitive is the first primitive to be stored for a primitive list, memory space for a primitive list is allocated as part of the processing of the primitive, and a pointer 72 indicating the location in storage of the primitive list is written to the primitive list pointer array 71 for the layer.

In this embodiment, initialisation S207 of the primitive list pointer array 71 for a layer is performed in a non-blocking manner, such that processing S208 of a primitive continues whilst the primitive list pointer array 71 for the layer is initialised S207.

Particularly, when a (new) primitive list is required to store a primitive, a pointer 72 indicating the location of the primitive list is (first) written to a (pointer) cache 36. As such, the (pointer) cache 36 temporarily stores the location of the primitive list. Once a primitive list pointer array 71 has been initialised S207, any primitive list pointers 72 for that primitive list pointer array 71 can be written from the (pointer) cache to the primitive list pointer array 71.

In this way, primitives can be processed to sort the primitives into a respective primitive list(s) even whilst the primitive list pointer array(s) required to store the location of the primitive list(s) is being initialised.

As in this embodiment a primitive list pointer array 71 is only allocated when there is a primitive to be included in a corresponding primitive list, this embodiment will not allocate and initialise primitive list pointer arrays 91 for any render layers that do not in fact contain graphics primitives. This may then reduce the amount of space in memory that is allocated for the primitive list pointer arrays 71 storing pointers 72 indicating the locations of primitive lists, as compared to, for example, the arrangement of FIGS. 5 and 6.

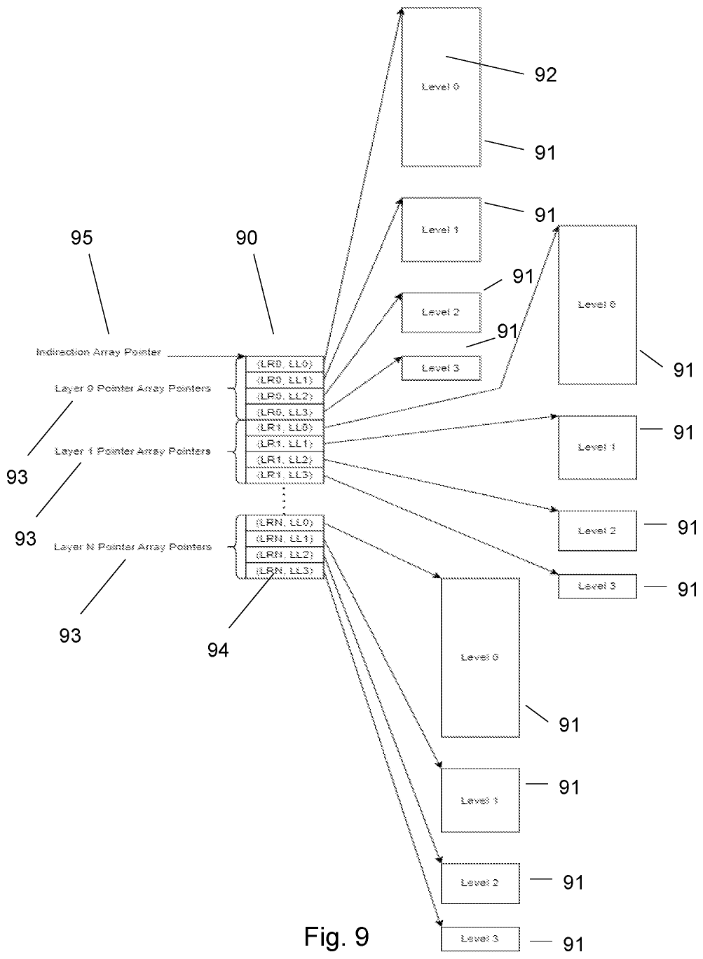

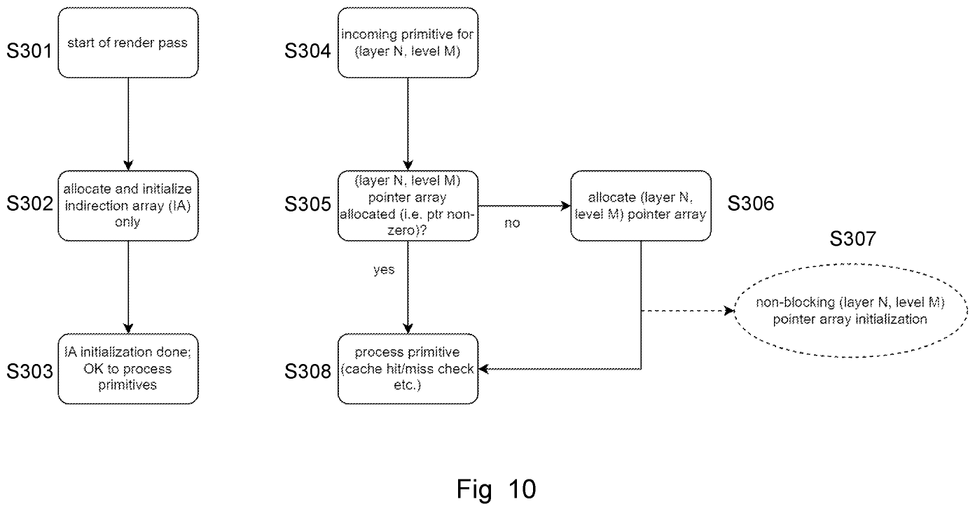

FIGS. 9 and 10 show the storage of locations of primitive lists in a second embodiment of the technology described herein.

FIG. 9 shows the data structure used for indicating primitive list locations in this embodiment. As shown in FIG. 9, in this embodiment, a separate primitive list pointer array 91 is used to store pointers 92 indicating the location of primitive lists. for each particular hierarchical level within each particular render layer.

In this embodiment a further pointer array (an indirection array) 90 is again used to store further pointers 94 that indicate the locations of the respective primitive list pointer arrays 91.

The further pointer array 90 has an entry for storing a (further) pointer 94 indicating a location in storage for each primitive list pointer array that could be required, and so in the present embodiment includes an entry for each respective hierarchy level of each render layer (that the graphics processor can potentially be required to generate).

FIG. 10 shows an embodiment for storing the locations of primitive lists using the data structures of FIG. 9.

In this embodiment, like in the method of FIG. 8, at the start of the render pass S301, (only) the further pointer array 90 is allocated and initialised S302 by writing zero values to each entry in the array.

Once the further pointer array has been allocated and initialised S303, primitives are processed.

For an incoming primitive S304 for a particular hierarchical level within a particular render layer, it is determined whether the primitive list pointer array 91 for that hierarchical level has been allocated S305. This is done in the same way as described above with respect to the method of FIG. 8.

When it is determined that a primitive list pointer array 91 has already been allocated for the particular hierarchical level within the particular render layer, then the primitive is processed S308 and added to the desired primitive lists(s) for that level.

When it is determined that a primitive list pointer array 91 has not already been allocated for the particular hierarchical level within the particular render layer, then the primitive list pointer array 91 for the hierarchical level is allocated S306, and a (further) pointer 94 is written to the corresponding entry in the further pointer array 91 to indicate a location in storage of the (new) primitive list pointer array 91 for the particular hierarchical level within the particular render layer, in the same way as described above with respect to FIG. 8.

Again, the primitive is processed S308 and added to the desired primitive list(s) for that particular hierarchical level within the particular render layer

Like in the embodiment described above with respect to FIG. 8, in this embodiment processing of the primitive S308 is performed concurrently with initialisation of the primitive list pointer array 91 (the initialisation is performed in a non-blocking manner), by first writing pointers 92 indicating the location of a (new) primitive list to a (pointer) cache 36, and then, once initialisation of the appropriate primitive list pointer array 91 is complete, writing the pointers to the primitive list pointer array 91.

As in this embodiment, a primitive list pointer array 91 is only allocated when there is a primitive to be included in a corresponding primitive list, this embodiment will not allocate and initialise primitive list pointer arrays 91 for any hierarchical layers that do not in fact contain graphics primitives, thereby providing finer control over the allocation and initialisation of primitive lists pointer arrays, which may provide a further reduction in the amount of space required for storing the location of primitive lists.

As will be appreciated from the above, the technology described herein, in its embodiments at least, can provide for more efficient storage and tracking of the locations of primitive lists in a tile-based graphics processing system. This is achieved in the embodiments of the technology described herein at least, by storing a further pointer array comprising further pointers, the further pointers indicating respective locations in memory of primitive list pointer arrays. The primitive list pointer arrays store pointers indicating the location in memory of primitive lists, in an embodiment for a respective render layer or hierarchical level within a render layer.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of preparing and storing primitive lists for use in a tile-based graphics processing system, in which a render output to be generated is divided into a plurality of tiles for rendering purposes, with each tile of the render output being rendered separately, the method comprising:
preparing and storing one or more primitive lists, each primitive list indicating graphics primitives to be processed for a region of the render output;
storing in one or more primitive list pointer arrays, one or more pointers, each pointer indicating a location in storage of one or more of the primitive lists; and
storing in a further pointer array, one or more further pointers, each further pointer indicating a location in storage of one or more of the primitive list pointer arrays.

2. The method of claim 1, comprising preparing and storing primitive lists for plural sets of regions of the render output.

3. The method of claim 2, wherein a primitive list pointer array stores locations in memory of primitive lists prepared for a respective one of the sets of regions of the render output.

4. The method of claim 1, comprising preparing primitive lists for each of multiple render layers, wherein a respective primitive list pointer array indicates the location in memory of primitive lists for a respective render layer.

5. The method of claim 1, comprising preparing a hierarchical set of primitive lists for each of multiple render layers, wherein a respective primitive list pointer array indicates the location in memory of primitive lists for a respective hierarchical level of a respective render layer.

6. The method of claim 1, comprising allocating and initialising memory space for the further pointer array prior to preparing and storing primitive lists.

7. The method of claim 1, comprising only allocating and initialising memory space for a primitive list pointer array when it is determined that the primitive list pointer array is required to store a location of a primitive list.

8. The method of claim 1, wherein preparing and storing the primitive lists comprises:
for a primitive for the render output:
determining a set of regions of the render output the primitive is to be listed for;
determining whether the further pointer array comprises a further pointer indicating a location in storage of a primitive list pointer array for the set of regions, and:
when it is determined that the further pointer array does not comprise a further pointer indicating a location in storage of a primitive list pointer array for the set of regions of the render output:
allocating and initialising a primitive list pointer array for the set of regions of the render output; and
writing a further pointer indicating a location in storage of the primitive list pointer array in the further pointer array.

9. The method of claim 1, wherein storing in one or more primitive list pointer arrays, one or more pointers, each pointer indicating a location in storage of one or more of the primitive lists, comprises:
when a location in storage for a primitive list is allocated, writing a pointer indicating a location in storage of the primitive list to a cache; and
when a primitive list pointer array for storing the pointer has been initialised, writing the pointer from the cache to the primitive list pointer array.

10. A method of reading primitive lists when performing tile-based graphics processing in which a render output to be generated is divided into a plurality of tiles for rendering purposes, with each tile of the render output being rendered separately, the method comprising:
when reading a primitive list to identify a primitive(s) to process for a tile of a render output:
reading a further pointer from a further pointer array that stores one or more further pointers, each further pointer indicating a location in storage of one or more primitive list pointer arrays, to determine a location in storage of a primitive list pointer array comprising a pointer indicating the location in storage of the primitive list;
reading a pointer from the primitive list pointer array that indicates the location in storage of the primitive list; and
reading the primitive list to identify a primitive(s) to be processed.

11. A tile-based graphics processor, the graphics processor operable to render graphics processing render outputs in a tile-based manner, in which a render output being generated is divided into a plurality of tiles for rendering purposes, with each tile of the render output being rendered separately;
and the graphics processor comprising:
a tiling circuit configured to prepare and store in memory, a primitive list comprising graphics primitives to be processed for each of one or more regions of a render output to be generated;
wherein the tiling circuit is configured to, when preparing and storing primitive lists:
store in one or more primitive list pointer arrays, one or more pointers, each pointer indicating a location in memory of one or more of the primitive lists; and
store in a further pointer array, one or more further pointers, each further pointer indicating a location of one or more of the primitive list pointer arrays.

12. The tile based graphics processor of claim 11, wherein the tiling circuit is configured to prepare and store primitive lists for plural sets of regions of the render output.

13. The tile based graphics processor of claim 12, wherein the tiling circuit is configured to store, in a respective primitive list pointer array, locations in memory of primitive lists prepared for a respective one of the sets of regions of the render output.

14. The tile based graphics processor of claim 11, wherein the tiling circuit is configured to prepare primitive lists for each of multiple render layers, wherein a respective primitive list pointer array indicates the location in memory of primitive lists for a respective render layer.

15. The tile based graphics processor of claim 11, wherein the tiling circuit is configured to prepare a hierarchical set of primitive lists for each of multiple render layers, wherein a respective primitive list pointer array indicates the location of primitive lists for a respective hierarchical level of a respective render layer.

16. The tile based graphics processor of claim 11, wherein the tiling circuit is configured to allocate and initialise the further pointer array prior to preparing and storing primitive lists.

17. The tile based graphics processor of claim 11, wherein the tiling circuit is configured allocate and initialise a primitive list pointer array in response to it being determined that the primitive list pointer array is required to store a location of a primitive list.

18. The tile based processor of claim 11, wherein the tiling circuit is configured to, when preparing and storing primitive lists:
for a primitive for the render output:
determine a set of regions of the render output the primitive is to be listed for;
determine whether the further pointer array comprises a further pointer indicating a location in storage of a primitive list pointer array for the set of regions, and:
when it is determined that the further pointer array does not comprise a further pointer indicating a location in storage of a primitive list pointer array for the set of regions of the render output:
allocate and initialise a primitive list pointer array for the set of regions of the render output; and
write a further pointer indicating a location in storage of the primitive list pointer array in the further pointer array.

19. The tile based graphics processor of claim 11, wherein the tiling circuit is configured to, when storing in one or more primitive list pointer arrays, one or more pointers, each pointer indicating a location in storage of one or more of the primitive lists:
when a location for a primitive list is allocated, write a pointer indicating a location of the primitive list to a cache; and
when a primitive list pointer array for storing the pointer has been initialised, write the pointer from the cache to the primitive list pointer array.

20. A non-transitory computer readable storage medium storing computer software code which when executing on at least one processor, performs a method of preparing and storing primitive lists for use in a tile-based graphics processing system, in which a render output to be generated is divided into a plurality of tiles for rendering purposes, with each tile of the render output being rendered separately, the method comprising:
preparing and storing one or more primitive lists, each primitive list indicating graphics primitives to be processed for a region of the render output;
storing in one or more primitive list pointer arrays, one or more pointers, each pointer indicating a location in storage of one or more of the primitive lists; and
storing in a further pointer array, one or more further pointers, each further pointer indicating a location in storage of one or more of the primitive list pointer arrays.
